(19) United States
(12) Patent Application Publication
(10) Pub. No.: US 2007/0254081 A1
(43) Pub. Date: Nov. 1, 2007

(54) BINARY FLUIDIC FOOD FLAVORING SYSTEM

(76) Inventor: MICHAEL CULLEN, Sudbury (CA)

Correspondence Address: J. GORDON THOMSON, P.O. BOX 8865, VICTORIA, BC, V8V 3Z1, US

(21) Appl. No.: 11/739,423

(22) Filed: Apr. 24, 2007

Related U.S. Application Data
(60) Provisional application No. 60/745,661, filed on Apr. 26, 2006.

(51) Int. Cl. A23L 1/22

(52) U.S. Cl. 426/534

(57) ABSTRACT

Binary flavoring solutions comprise a first flavoring solution comprising a first base flavor and a second flavoring solution comprising a second base flavor. The first and second flavors combine to create a desired flavoring effect. The solutions are created from predetermined flavors. The solutions are combined in a binary spray nozzle adapted for combining fluids and applied to the food in combination as a spray.

### RELATED APPLICATIONS

This application claims priority from my previously filed U.S. Provisional Patent Application No. 60/745,661 filed on Apr. 26, 2006.

### TECHNICAL FIELD

This invention relates to compositions of food or edible materials and more specifically to a binary fluidic food flavoring system.

### BACKGROUND

Dry spices do not retain moisture in the food they are applied to. As well, when applying dry spices in an outdoor situation, such as a BB-Q, prevailing winds can carry much of the spices away. This wastes the product and does nothing to enhance the taste of food. Furthermore, the application of dry spices does nothing to retain moisture in the food while it is cooking. A number of attempts have been made to overcome this problem. For example, U.S. Pat. No. 5,650,185 Non-aerosol, uniform spray dispersion system for oil-based products” issued to Stoltz on Jul. 22, 1997 teaches a liquid vegetable oil-based formation incorporating a particular flavoring that is sprayed on food using a finger actuated spray pump. However, Stoltz relies on the use of oil-based flavorings and high pressure pumps. Oil-based flavorings are not necessarily healthy and result in a heavy flavor. The need for a high pressure pump complicates the delivery system and increases the cost of the delivery system. U.S. Pat. No. 4,778,068 “Aerosol food flavoring compositions” issued to Konishi et al on Nov. 29, 1998 teaches a food flavoring enhancing aerosol packaged food sprays comprising a high degree of undissolved solids as well as oils and emulsifiers. The use of oil-based flavorings teaches away from my invention which is intended to provide healthy and natural flavorings to foods.

### SUMMARY OF THE INVENTION

To overcome this problem, my invention comprises binary flavoring solutions and methods for preparation and application that is adapted to contain base flavorings in a water solution for wet spray applications to foods. This not only ensures that most of the flavoring reaches the food but helps to retain moisture of the food while it is cooking. My invention is also adapted to be fun to use and entertaining to persons watching the cooking process. My invention ensures that a spray application covers a wide area of food being cooked and therefore is economical and does not waste product. My invention comprises the combination of independent flavoring solutions in a spray mechanism and discharging the combined solutions in the nozzle stream. Independently each solution does not necessarily enhance the flavor of the food product. However, when combined, the result is a pleasant and novel taste experience that cannot be achieved by the consecutive additions of the solutions independently.

My invention is designed to be a binary spray system. There is a first bottle containing a first flavoring solution and a second bottle containing a second flavoring solution. The liquids are water-based so that they have a suitable viscosity in order to pass through the spray apparatus nozzle. For example, there may be vinegar in one bottle and a roasted garlic juice in another bottle. These bottles are connected to a common spray nozzle. When the spray is activated, the two liquids are combined at the spray head and the combined liquid is propelled toward the food. Understandably, the nozzles will easily clog if particulate matter is forced through them. Therefore, the flavoring solutions must not contain particulates in order to avoid clogging. Water-based solutions are therefore most adaptable to my invention.

In my invention, the bottles of individual flavoring solutions will be bottled and sold separately. In this way the consumer is able to pick and choose various combinations of flavoring solutions for maximum flavor variations when they are combined.

In another example of my invention the flavoring solutions are mixed and applied using a dual-liquid spray bottles. These types of applicators are known and available commercially. One suitable example is made and sold by Deardorff Fitzsimmons Corp as its DLS 100™ and DLS 200™ sprayer that utilizes twin bottles. These bottles have fixed ratio and variable ratio spray nozzles to adjust the fluid flow from each bottle. The fluids are mixed in the spray head and then ejected out of the nozzle as a combined spray. The ratios are adjustable to 64:1.

In my invention the flavoring solutions will be developed using tasting techniques and tests and proper formulations will be specified to achieve the desired flavor.

Depending on the type of spray bottles used, the spray will mix the individual flavoring solutions in either the spray head of the spray apparatus or downstream from the nozzle from a two-spray head system.

### DESCRIPTION OF THE DRAWINGS

FIG. 1 is a schematic drawing of the flavoring delivery system of one example of my invention.

### DETAILED DESCRIPTION

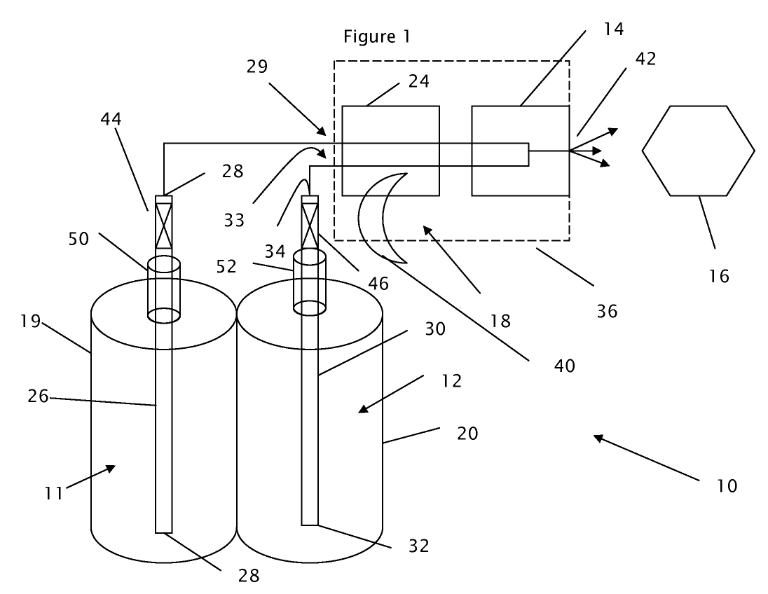

Referring to FIG. 1, one example of my invention is illustrated as a binary food flavoring system (10) comprising a first flavoring solution (11) comprising a first base flavor and a second flavoring solution (12) comprising a second base flavor. The first base flavor and said second base flavor are combined in a mixing chamber (14) prior to deposition on a food (16) by spray deposition means (18) resulting in a desired flavoring effect.

The first flavoring solution (11) is contained within a first reservoir (19) and the second flavoring solution (12) is contained in a second adjacent reservoir (20). The first reservoir and said second adjacent reservoir have fluidic independence, that is, they are not connected to each other.

The first reservoir (19) is in fluidic communication with said deposition means comprising a spray pump (24) by way of a first conduit (26) having a first end (28) immersed in the first flavoring solution (11) and a second end (28) connected to the first suction (29) of the spray pump (24). The second reservoir (20) is in fluidic communication with the spray pump by way of a second conduit (30) having a first end (32) immersed in the second flavoring solution (12) and a second end (34) connected to the second suction (33) of the spray pump (24).

A housing (36) houses the spray pump (24) and mixing chamber (14) adapted to receive a first quantity of the first flavoring solution from the first reservoir and a first quantity of the second flavoring solution from the second reservoir. The first quantity of the first flavoring solution and the first quantity of the second flavoring solution are forceably mixed together within the mixing chamber to form a mixed flavoring solution.

The spray pump further comprises a finger actuated trigger (40) for manual pumping.

The spray pump further comprises a discharge nozzle (42) for discharging the mixed flavoring solution onto the food (16) as a consistent and uniform spray dispersal pattern. The discharge nozzle is also adapted for discharging the fixed flavoring solution as a fluidic stream.

The first (19) and the second (20) reservoirs can be isolated from the spray pump (24) by isolation means comprising a first valve (44) and a second valve (46) respectively. As well, the ratio of the quantity of the first flavoring solution drawn from the first reservoir to the quantity of the second flavoring solution drawing from the second reservoir can be adjusted by throttling the first and second valves as desired.

In one example of the invention, the first and the second flavoring solutions comprise a major amount of water and a minor amount of first and second base flavoring.

In another example of my invention there is provided a fluidic binary food flavoring deliver system comprising a spray pump (24) for providing a consistent fluidic spray dispersal pattern on food (16); a first reservoir (19) for containing a first flavoring solution (11) comprising a first base flavor in fluidic communication with the spray pump (24); a second reservoir (20) for containing a second flavoring solution (12) comprising a second base flavor in fluidic communication with the spray pump (24); a mixing chamber (14) in fluidic communication with the spray pump (24) and downstream thereof for mixing equal amounts of the first and second flavoring solutions; and, a discharge orifice (42) adjustable to produce spray patterns ranging from aerosol to stream so that the combined first and second flavoring solutions are deposited on a food product as an enhanced flavor. In this example, the first and the second flavoring solutions comprise a majority part of water and a minority part of base flavoring. In this example, the first and second reservoirs are removably attached to the spray pump.

In another example of my invention, the first and second base flavors are chosen from of a plurality of flavors adapted for enhanced flavoring upon combination. In one example of my invention the first and second reservoirs are comprised of translucent polyvinyl containers having a removeable caps (50) and (52) for sealing the reservoirs for flavor preservation prior to connection with the spray pump. In this way the first and second reservoirs may be removed from the spray pump and recapped for storage and refrigeration. The first and second reservoirs are refillable and recyclable.

In another example of my invention and in order to accommodate a wide variety of flavorings the first (19) and second (20) reservoirs are individually packaged and retailed apart from the spray pump. Each reservoir contains a specific flavoring fluid that when combined with another flavoring fluid of my invention results in a unique and pleasing taste.

In one example of my invention, a kit is provided for retail sale comprising a binary spray pump (24) comprising a first and a second reservoir connector, a finger actuated spray pump (24), an internal mixing chamber (14) and an adjustable spray nozzle (42); a first sealed reservoir (19) containing a first flavoring solution (11) for connection to the first reservoir connector; a second sealed reservoir (20) containing a second flavoring solution (12) for connection to the second reservoir connector; and transparent packaging for containing the food flavoring kit. Equal amounts of the first and the second flavoring solutions are mixed in the mixing chamber (14) prior to discharge from the spray nozzle (42). In this example, the consumer is able to purchase additional sealed reservoirs containing additional flavors in order to experience a wide range of combinations and resulting flavors.

Some typical flavoring compositions are:

### EXAMPLE 1

a composition comprising raspberry-baco noir vinegar; water; corn syrup; natural flavorings of raspberry; grape concentrate and maple sugar.

### EXAMPLE 2

a composition comprising filtered water, concentrated lemon juice, citric acid, lemon flavor and sodium benzoate.

### EXAMPLE 3

a composition comprising balsamic-baco noir vinegar; water, sugar, maple syrup and natural flavorings.

### EXAMPLE 4

a composition comprising garlic juice, water, salt and citric acid.

The consumer would preferably purchase a reservoir of the composition of example 1 and a reservoir of the composition of example 3 and install them on the spray pump to create a pleasing flavor experience.

Similarly the consumer would preferably purchase a reservoir of the composite of Example 2 and a reservoir of Example 4 for another flavor experience.

It is understood that a plurality of reservoirs of different flavors can be purchased to increase the number of possible combinations of flavors and to create an enjoyable cooking and eating experience for the consumer.

Certain changes may be made to the above description without departing from the scope of the invention. The following claims are intended to cover all of the generic and specific features of the invention including and not limited to any and all compatible mixtures of flavoring solutions and sizes of reservoirs.

What is claimed is:

1. A binary food flavoring system comprising a first flavoring solution comprising a first base flavor and a second flavoring solution comprising a second base flavor where in said first base flavor and said second base flavor are combined prior to deposition on a food by spray deposition means resulting in a desired flavoring effect.

2. The system of claim 1 wherein said first flavoring solution is contained within a first reservoir and said second flavoring solutions is contained in an second adjacent reservoir and wherein said first reservoir and said second adjacent reservoir have fluidic independence.

3. The system of claim 2 wherein the first reservoir is in fluidic communication with said deposition means comprising a spray pump by way of a first conduit having a first end immersed in the first flavoring solution and a second end connected to the suction of said spray pump and wherein the second reservoir is in fluidic communication with the pump by way of a second conduit having a first end immersed in the second flavoring solution and a second end connected to the suction of the spray pump.

4. The system of claim 3 further comprising a spray pump head for housing the spray pump and a mixing chamber adapted to receive a first quantity of the first flavoring solution from the first reservoir and a first quantity of the second flavoring solution from the second reservoir, and further wherein said first quantity of the first flavoring solution and said first quantity of the second flavoring solutions are forceably mixed together within said mixing chamber as a mixed flavoring solution.

5. The system of claim 4 wherein the spray pump further comprises a finger actuated trigger for manual pumping.

6. The system of claim 5 wherein the spray pump further comprises a discharge nozzle for discharging said mixed flavoring solution as a consistent and uniform spray dispersal pattern.

7. The system of claim 5 wherein said discharge nozzle is adapted for discharging the fixed flavoring solution as a fluidic stream.

8. (canceled)

9. The system of claim 7 wherein the first flavoring solution comprises a major amount of water and a minor amount of first base flavoring and wherein the second flavoring solution comprises a major amount of water and a minor amount of second base flavoring.

10. A fluidic binary food flavoring deliver system comprising a spray pump for providing a consistent fluidic spray dispersal pattern; a first reservoir for containing a first flavoring solution comprising a first base flavor in fluidic communication with said spray pump; a second reservoir for containing a second flavoring solution comprising a second base flavor in fluidic communication with the spray pump; a mixing chamber in communication with the spray pump and downstream thereof for mixing equal amounts of said first and second flavoring solutions; and, a discharge orifice adjustable to produce spray patterns ranging from aerosol to stream so that the combined first and second flavoring solutions are deposited on a food product as an enhanced flavor.

11. The binary system of claim 10 wherein the first and the second flavoring solutions comprise a majority part of water and a minority part of base flavoring.

12. The binary system of claim 11 wherein the first and second reservoirs are removably attached to the spray pump.

13. The binary system of claim 12 wherein the first and second base flavors are chosen from of a plurality of flavors adapted for enhanced flavoring upon combination.

14. The binary system of claim 13 wherein the first and second reservoirs are comprised of translucent polyvinyl containers having a removeable cap, wherein said removeable cap is sealed prior to connection with the spray pump, so that the first and second reservoirs may be removed from the spray pump and recapped for storage.

15. The binary system of claim 14 wherein the first and second reservoirs are refillable.

16. The binary system of claim 15 wherein the first and second reservoirs are recyclable.

17. The binary system of claim 16 wherein the first and second reservoirs are individually packaged and retailed apart from the spray pump.

18. A food flavoring kit comprising a binary spray pump comprising a first and a second reservoir connector, a finger actuated spray mechanism, an internal mixing chamber and an adjustable spray nozzle; a first sealed reservoir containing a first flavoring solution for connection to said first reservoir connector; a second sealed reservoir containing a second flavoring solution for connection to said second reservoir connector; and transparent packaging for containing said food flavoring kit.

19. The kit of claim 18 wherein equal amounts of said first and said second flavoring solutions are mixed in said mixing chamber prior to discharge from said spray nozzle.

20. The kit of claim 19 wherein said first and said second sealed reservoirs are retailed apart from the spray pump.
